(19) United States
(12) Patent Application Publication
(10) Pub. No.: US 2021/0312894 A1
(43) Pub. Date: Oct. 7, 2021

(54) ELECTRONIC CAJON

(71) Applicant: Roland Meinl Musikinstrumente GmbH & Co. KG, Gutenstetten (DE)

(72) Inventor: Reinhard WENING, Dietenhofen (DE)

(21) Appl. No.: 17/218,711

(22) Filed: Mar. 31, 2021

(30) Foreign Application Priority Data
Apr. 2, 2020 (DE) 10 2020 204 279.9

(51) Int. Cl. G10D 13/10; G10D 13/02; G10H 3/14; G10H 1/00; G10H 1/34; G10H 1/053

(52) U.S. Cl. CPC G10D 13/26; G10D 13/02; G10H 3/143; G10H 2220/161; G10H 1/348; G10H 1/053; G10H 2220/525; G10H 1/0008

(57) ABSTRACT

An electronic cajon comprises a box-like base body with a bottom wall, side walls and a cover wall, wherein
the playing surface is sub-divided into a plurality of beat effect zones,
the beat effect zones each have a beat converting device arranged in a storage compartment formed in the front wall,
the beat converting device has
   a rubber-like impact plate forming the operation surface of each beat effect zone,
   a mechanical-electrical signal converter mounted on the inner side of the impact plate and
   a shock absorption inlay arranged between the impact plate and a bottom of the storage compartment around the signal converter, and
a sound module assigned to the signal converters is provided, which converts the electrical signals from the signal converters into electrical sound signals and outputs them at an output of the electronic cajon.

### CROSS-REFERENCES TO RELATED APPLICATIONS

This application claims the priority of German Patent Application, Serial No. 10 2020 204 279.9, filed on Apr. 2, 2020, pursuant to 35 U.S.C. 119(a)-(d), the content of which is incorporated herein by reference in its entirety as if fully set forth herein.

### FIELD OF THE INVENTION

The invention relates to an electronic cajon comprising a box-like base body with a bottom wall, side walls, of which the front wall forms a playing surface, as well as a cover wall, which serves as a seating surface for the player.

### BACKGROUND OF THE INVENTION

With traditional cajons, sound is produced by beating the playing surface. By means of different additional components, such as so-called snare elements, and by beating onto different zones of the playing surface, different sound effects, such as a high sound based on the sound of a snare drum, a bass sound or a so-called tip or slap sound can be produced.

Acoustic cajons usually are very noisy, even if they are played cautiously, with the result that a practice play is not possible without disturbing third parties, for example in a rented apartment or in a shared apartment.

An entirely different aspect is the electrical amplification of such acoustic cajons, which may be necessary when a larger auditorium shall be filled with sound. In this context, electronically amplified cajons are already known, in which an impact on the playing surface is captured by means of a mechanical-electrical signal converter, such as a piezo element, or by means of a microphone placed inside the cajon, and then converted into a correspondingly amplifiable sound signal. The cajon sound is then output in an amplified manner via an amplification system.

From U.S. Pat. No. 9,589,552 B1 and U.S. Pat. No. 10,147,409 B2 it is basically known to transmit the mechanical impact on the playing surface of a drum or cajon onto a piezo element by means of a conical foam part in order to produce an electrical pickup signal for amplified play of the sound of the cajon.

The aforementioned electronic cajons do not offer any solution to the issue explained above that during a normal, non-electrically amplified playing of the cajon, a disturbance of the environment results.

From the Spanish utility model ES 1124705 U, however, an electronic cajon is known whose upper zone of the front wall is provided with an impact surface pad, known from so-called “electronic drum sets”. These elastic pads are characterized in that by means of beating onto it, an electrical signal is produced, with the help of which a sound production unit—in the following continuously called “sound module”—is triggered, and a corresponding electrical sound signal is produced for output. Due to the elasticity of the pads, the impacts are absorbed significantly, and playing the cajon as such can take place in a relatively silent manner. If the sound signals are output via a headphone, such a cajon can be used in an optimal manner as a practice instrument even in an environment which is susceptible to acoustic disturbance.

A drawback of known electronic cajons is the fact that the pads providing for the conversion of the impacts into electrical signals are rather intended for being played on with drum sticks and thus are not construed in an optimal manner for the application with a cajon. Moreover, these pads are relatively cost-intensive.

### SUMMARY OF THE INVENTION

It is therefore an object of the invention to provide an electronic cajon which can be played on in an especially silent manner, while being construed in a constructively simple manner without losses in the electrical signal quality. This makes the instrument particularly suitable for practice application in an environment which is sensitive to noise.

This object is achieved by an electronic cajon comprising a box-like base body with a bottom wall, side walls, of which the front wall forms a playing surface, as well as a cover wall, which serves as a seating surface for the player, wherein
the playing surface is sub-divided into a plurality of beat effect zones with sound effects assigned thereto,
the beat effect zones each have a beat converting device arranged in a storage compartment formed in the front wall,
the beat converting device has
   a rubber-like impact plate forming the operation surface of each beat effect zone,
   a mechanical-electrical signal converter mounted on the inner side of the impact plate and
   a shock absorption inlay arranged between the impact plate and the bottom of the storage compartment around the signal converter, as well as
a sound production unit (“sound module”) assigned to the signal converters is provided, which converts the electrical signals from the signal converters into electrical sound signals corresponding to the sound effects of the beat effect zones and outputs them at an output of the electronic cajon.

The cajon according to the invention has numerous advantages. For instance, basically, by using a plurality of beat effect zones, an instrument is provided which can be operated silently while being able to produce a sound spectrum which is at least comparable to a classic acoustic cajon, if not broader.

The use of a rubber-like plate as playing surface results in an especially silent operation. At the same time, mounting the signal converter to the inner side of the impact plate ensures an effective transmission of the mechanical signal from the impact plate to the signal converter. Additionally, the shock absorption inlay surrounding the signal converter acoustically further reduces noise and mechanically provides for an absorbing lining of the impact plate. In this context, the formation of the beat converting device according to the invention and in particular its accommodation in a respective storage compartment in the front wall represents a very simple construction which can be produced in a cost-efficient manner while being sufficiently robust.

In the dependent claims, preferred further developments of the object of the invention are indicated, which for the sake of avoiding unnecessary repetition are explained in detail with their features and advantages in the following description of an embodiment with reference to the attached drawings.

### BRIEF DESCRIPTION OF THE DRAWINGS

FIG. 1 shows a schematic, perspective front view of a cajon with partially cut away impact plates,

FIG. 2 shows a side view of the cajon according to FIG. 1 with a partial vertical section of the front wall and the cover wall,

FIG. 3 shows a partial side view of the front wall of the cajon,

FIGS. 4 and 5 show partial vertical sections of the front wall corresponding to the section lines IV-IV and V-V according to FIG. 3,

FIG. 6 shows a perspective view of the cajon according to FIG. 1 from behind, as well as

FIG. 7 shows a view of a sound module applied in the cajon.

### DESCRIPTION OF THE PREFERRED EMBODIMENT

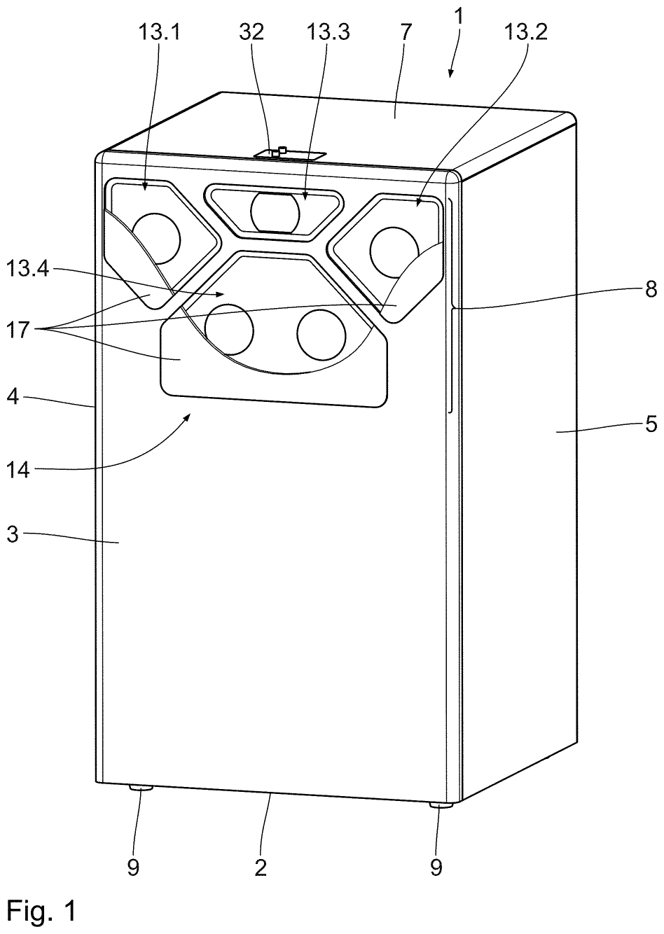

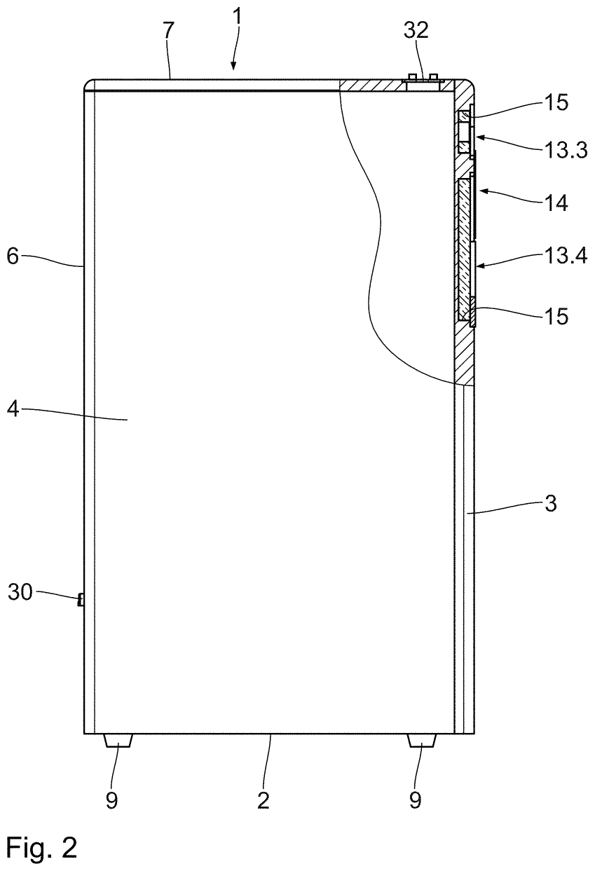

As becomes apparent from FIG. 1, the electronic cajon has a box-like base body 1 consisting of a bottom wall 2, a front wall 3, two side walls 4, 5, a rear wall 6 and a cover wall 7. The front wall 3 forms a playing surface 8 extending from above the center to the cover wall 7 and over the entire width to the side walls 4, 5. The cover wall 7 serves as a seating surface for a player who is not shown in further detail. For improving its stability, the cajon is provided with feet 9.

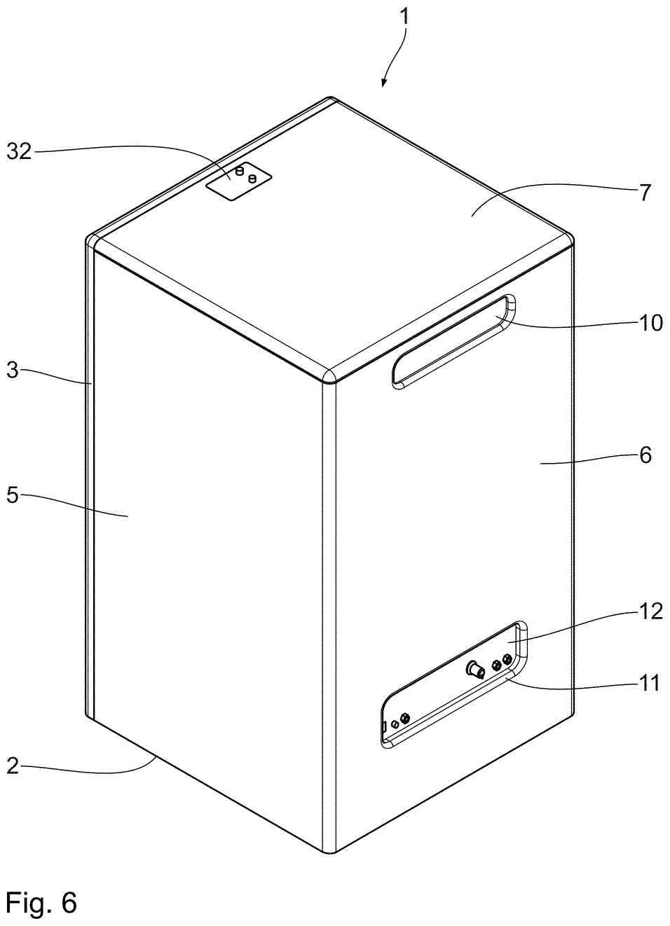

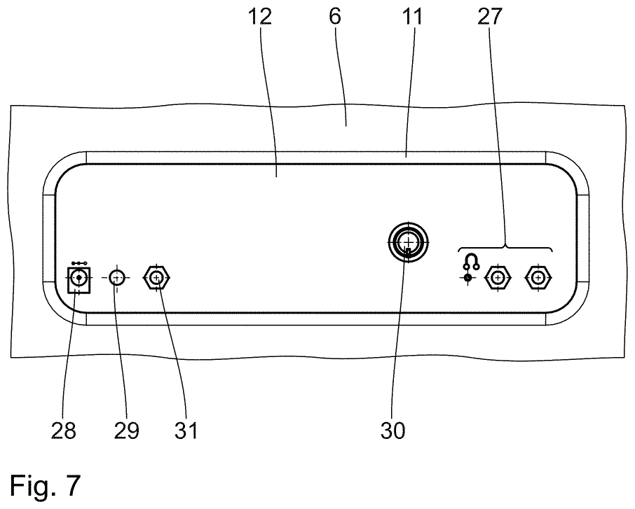

In the rear wall 6—as can be seen in FIG. 6—a grip hole 10 is provided in front of the upper edge towards the cover wall 7. Furthermore, a sound hole may be provided, which is not shown in further detail. In the lower area of the rear wall 6, a sound module 12 mounted to the rear wall 6, whose front side is shown in FIG. 7 and whose function and operating elements are described below in further detail, is accessible via a window 11.

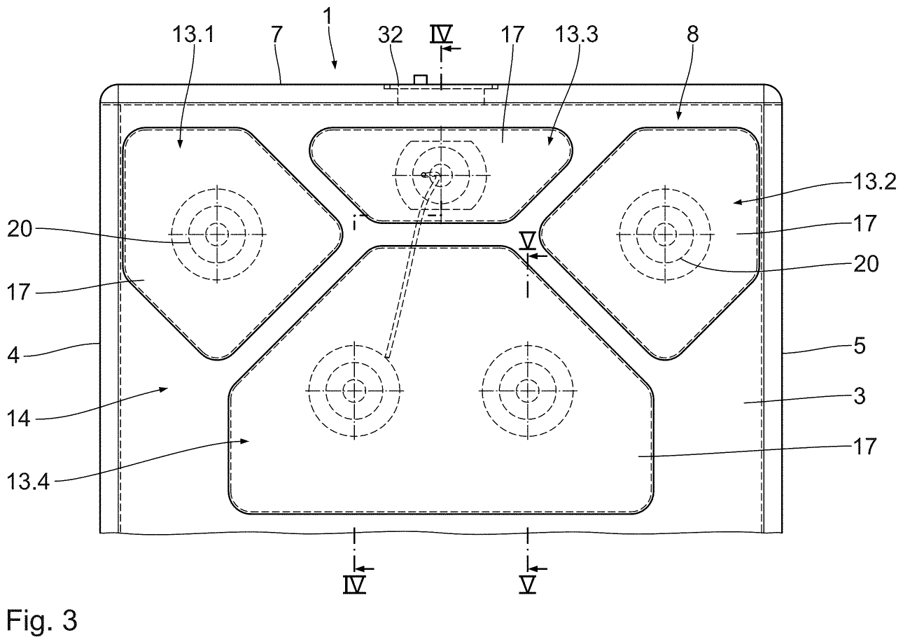

As becomes apparent from a synopsis of FIGS. 1 and 3, the playing surface 8 of the front wall 3 is sub-divided into beat effect zones 13 corresponding to the beat positions which are usual with a cajon, which means the beat effect zones 13.1, 13.2. for the sound effect “snare” in the two upper corner areas, the about trapezoidal beat effect zone 13.3. for a “tip” or non-cajon sound effect centrically in between on the upper edge, and finally, the large hexagonal beat effect zone 13.4. for the sound effect “bass” centrically in the middle.

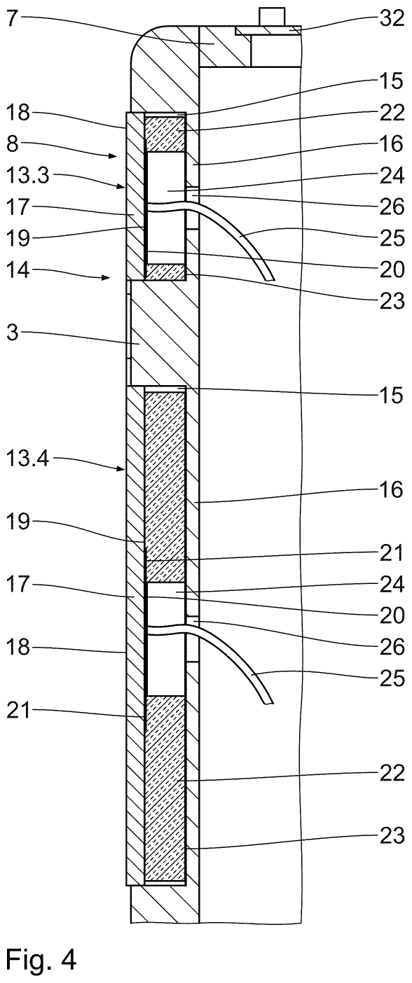

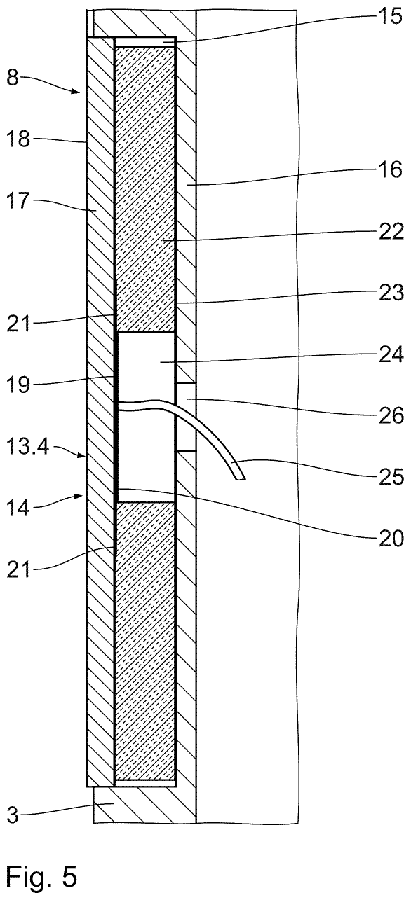

From FIGS. 3, 4 and 5, the detailed setup of the beat effect zones 13 is to be explained. For instance, each of these effect zones 13 has a signal converting device named 14 as a whole, each of which is accommodated in a storage compartment 15 formed in the front wall 3. The storage compartments 15, for example, can be milled from the front into the front wall 3 made of wood such that a bottom 16 of the storage compartment 15 remains on the inside.

The front opening of the storage compartments 15 is covered by a rubber-like impact plate 17, which for example is made of 4 mm thick vulcanized natural rubber or isoprene rubber. The surface 18 of the impact plate 17, pointing outwards, has a visual appearance of tissue. At the positions which can in particular be seen in FIG. 3, a disc-shaped mechanical-electrical signal converter 20 in the form of a common piezo element each is attached to the impact plates 17 from the back with a first layer 19 of double-sided adhesive tape, the lateral disc edges of which are lined by a shock absorption inlay 22 inserted between the impact plate 17 and the signal converter 20 on the one hand and the bottom 16 of the storage compartment 15 on the other hand Said shock absorption inlay 22 basically fills in the remaining storage compartment 15 and is glued to the impact plate 17 by the layer 19 of the double-sided adhesive tape and to the bottom 16 of the storage compartment 15 by a second layer 23 of double-sided adhesive tape.

In its center, the shock absorption inlay 22 has a circular opening 24 in which the signal converter 20 is located and through which a connecting cable 25 of the signal converter 20 passes. The cable is guided through another opening 26 in the bottom 16 of the storage compartments 15 into the inside of the cajon and further towards the sound module 12.

The shock absorption inlay 22 is made of a 9 mm thick open-celled acoustic foam of polyurethane, whose compression hardness for example is 6 kPa and whose volume weight (in German: Raumgewicht=RG) is RG40.

By beating the respective beat effect zone 13 with the hand, the corresponding impulse is dynamically transmitted to the signal converter 20. Due to this, the latter can produce a corresponding dynamic electrical signal which is fed to the sound module 12 arranged in the base body 1 via the respective connecting cable 25. The sound module 12 converts the electrical signals of the different signal converters 20 each assigned to a beat effect zone 13 into corresponding electrical sound signals which are output on a 2-channel output 27 of the cajon—see FIG. 7—having the form of usual connection sockets. With these, an amplifier or a playback device supplying a headphone can be actuated for sound reproduction of the played cajon.

Furthermore, as becomes apparent from FIG. 7, the sound module 12 has a power supply input 28, an on-off switch 29, a volume control knob 30 as well as a control input 31 realized by a corresponding socket. Via the latter, different sound effects saved in the sound module 12 can be retrieved preferably by means of a foot switch (not shown) connectable thereto. The activation of the various sounds can also take place via a selector switch 32 arranged on the front edge in the cover wall 7.

What is claimed is:

1. An electronic cajon comprising
a box-like base body (1) with a bottom wall (2), side walls (3-6), of which the front wall (3) forms a playing surface (8), as well as a cover wall (7), which serves as a seating surface for the player, wherein
the playing surface (8) is sub-divided into a plurality of beat effect zones (13) with sound effects assigned thereto,
the beat effect zones (13) each have a beat converting device (14) arranged in a storage compartment (15) formed in the front wall (3),
the beat converting device (14) has
a rubber-like impact plate (17) forming the operation surface of each beat effect zone (13),
a mechanical-electrical signal converter (20) mounted on the inner side of the impact plate (17) and
a shock absorption inlay (22) arranged between the impact plate (17) and a bottom (16) of the storage compartment (15) around the signal converter (20), as well as
a sound module (12) assigned to the signal converters (20) is provided, which converts the electrical signals from the signal converters (20) into electrical sound signals corresponding to the sound effects of the beat effect zones (13) and outputs them at an output (27) of the electronic cajon.

2. The cajon according to claim 1, wherein the beat effect zones (13) are arranged in the upper half of the front wall (3) and are construed for at least one of the group comprising the sound effects “bass”, “snare”, “tip”, “slap” and special non-cajon sound effects.

3. The cajon according to claim 2, wherein the beat effect zones (13.1; 13.2) for at least one of the group comprising “tip”, “slap” and special non-cajon sound effects preferably are arranged centrically in front of the upper edge of the front wall (3), the beat effect zone (13.3) for “snare” is arranged next to them in front of the two side edges of the front wall (3) and the beat effect zone (13.4) for “bass” then again is arranged below the latter centrically in the upper half of the front wall (3).

4. The cajon according to claim 1, wherein each of the impact plates (17) entirely covers the opening of the respective storage compartment (15).

5. The cajon according to claim 1, wherein each of the impact plates (17) is made of a vulcanized rubber material, preferably of one of the group comprising natural rubber and isoprene rubber.

6. The cajon according to claim 1, wherein the surface of each of the impact plates (17) is realized in the visual appearance of tissue.

7. The cajon according to claim 1, wherein the mechanical-electrical signal converter (20) is formed by means of a piezo element.

8. The cajon according to claim 1, wherein the shock absorption inlay (22) consists of an open-celled acoustic foam.

9. The cajon according to claim 1, wherein the shock absorption inlay (22) consists of polyurethane.

10. The cajon according to claim 8, wherein the acoustic foam of the shock absorption inlay (22) has a volume weight (in German: Raumgewicht=RG) of RG30 to RG50.

11. The cajon according to claim 10, wherein the acoustic foam of the shock absorption inlay (22) has a volume weight (in German: Raumgewicht=RG) of RG40.

12. The cajon according to claim 1, wherein the shock absorption inlay (22) has a through opening (26) in its direction of thickness, in which the mechanical-electrical signal converter (20) is arranged.

13. The cajon according to claim 1, wherein the impact plate (17) is connected with at least one of the group comprising the mechanical-electrical signal converter (20) and the shock absorption inlay (22), and the shock absorption inlay (22) is connected with the bottom (16) of the storage compartment (15), each by means of a layer (19, 23) of double-sided adhesive tape.

14. The cajon according to claim 1, comprising a separate control input (31) via which different sound effects that are saved in the sound module (12) can be retrieved.

15. The cajon according to claim 1, comprising a separate control input (31) via which, by means of a footswitch connectable thereto, different sound effects that are saved in the sound module (12) can be retrieved.

16. The cajon according to claim 1, wherein various sound effects saved in the sound module (12) can be retrieved by means of a selector switch (32) which preferably is arranged on the cover wall (7) of the cajon.
